(19) United States
(12) Patent Application Publication
(10) Pub. No.: US 2013/0124264 A1
(43) Pub. Date: May 16, 2013

(54) PRICE SIMULATION FOR ENTERPRISE SALES AND SUPPLY PROCESSES

(71) Applicants: Gururaj Raman, Bad Schornborn (DE); Balaji Vummiti, Bad Schornborn (DE)

(72) Inventors: Gururaj Raman, Bad Schornborn (DE); Balaji Vummiti, Bad Schornborn (DE)

(73) Assignee: SAP AG, Walldorf (DE)

(21) Appl. No.: 13/297,742

(22) Filed: Nov. 16, 2011

(51) Int. Cl. G06Q 30/02

(52) U.S. Cl. 705/7.35

(57) ABSTRACT

Embodiments of the present invention may provide a method to perform a price simulation. The method may comprise receiving search criteria for sales orders to perform simulation of price changes, selecting sales orders that satisfy the search criteria, and retrieving pricing attributes from the selected sales orders. The pricing attributes may include any discount(s) applied to a base price. The method may further comprise simulating application of a new pricing to affected sales orders according to the pricing attributes and storing simulation results.

### FIELD OF THE INVENTION

The disclosure relates to a system and method for providing price simulation in enterprise software applications, and in particular, estimation of price changes in sales and procurement processes.

### BACKGROUND

Setting competitive and profitable prices for products or services is one of the most important factors for a successful enterprise. On one hand, making the largest possible profit is the ultimate goal of every enterprise. On the other hand, arriving at the optimum price for a product or service is a big challenge. The pricing factors are complex and the strategy needs to be revisited often depending both on internal factors (cost, etc.) and external factors (competition, etc.).

In conventional enterprise software, when a transaction is completed, the price components used in completing the order are normally saved in a database with the order information. When a price simulation is needed, the conventional enterprise software is typically configured to return some random transaction documents. The price is then changed for those randomly selected transactions to see the effect of the price change. However, this kind of price simulation cannot show a clear picture of the effect of the price change. For example, a price change may be contemplated for orders when the order quantity reaches 100 or more. But the randomly selected transaction may only have an order quantity of 50. Thus, the correct price change impact is often missed by the conventional enterprise software.

Nevertheless, the need to simulation functionality based on historical documents is critical for decision making. It is extremely risky to do the price changes without knowing the impact on the sales and/or supply processes. Accordingly, there is a need in the art for providing a method and system for price simulation that can handle complex business needs and precisely predict price change impact to help business decision making.

### BRIEF DESCRIPTION OF THE DRAWINGS

FIG. 1 is a block diagram according to an exemplary embodiment of the present invention.

FIG. 2 is a sequence diagram for defining a price simulation according to an exemplary embodiment of the present invention.

FIG. 3 is a sequence diagram for executing a price simulation run according to an exemplary embodiment of the present invention.

FIG. 4 illustrates a process of applying different prices to a sales order simulation according to an exemplary embodiment of the present invention.

FIG. 5 illustrates a process of executing a price simulation run according to an exemplary embodiment of the present invention.

FIG. 6 is an exemplary system implementation according to an exemplary embodiment of the present invention.

FIG. 7 shows a structure of a computer running a price simulation according to an exemplary embodiment of the present invention.

FIG. 8 shows a multi-tier computer system for a price simulation according to an exemplary embodiment of the present invention.

### DETAILED DESCRIPTION

Embodiments of the present invention may provide an enterprise software application to deliver advanced pricing capabilities to product and/or service suppliers to optimize the pricing strategy. The enterprise software application may further deliver the functionality to do analysis on archived prices and discounts, simulate potential price and discount changes and execute new prices. In one embodiment, prices in the sales orders may be determined based on a pricing strategy. The strategy may define the steps of a sequence to be performed. Each step in the strategy may have a sequence rule from where the price per unit for calculation may be found. For example, the price may be $100/piece, or 10% discount of the base price. In some embodiments, the search criteria may include different prices (e.g., different discounts applied on a base price). For example, if a customer specific price is found in a sales order, then the customer specific price may be taken for the price calculation. However, if no customer specific price exists for the sales item then the search continues to find other prices, such as customer group price and further on. As seen above, simulation of changed prices may depend on attributes of the sales orders. Depending on value of the pricing attributes, an appropriate price may be determined and used as a basis for the price calculation. In another embodiment, the prices may depend on the sales item order quantity. This could be defined using scale prices. The scale prices may be price definitions based on certain scaling factors. For example, from 0 to 100 pieces price is 100 USD per 1 piece, more than 100 pieces price is 80 USD per 1 piece. The scale prices may also be discounts based on scale values. For example, 10% discount for quantity of more than 100 pieces, and 15% discount for quantity of more than 200 pieces.

Using an enterprise software application according to an embodiment of the present invention, users, such as sales managers, may compare simulated list prices/discounts with actual prices/discounts to identify gaps and potentials. Moreover, the enterprise software application may enable simulation of price changes on-the-fly based on historic sales orders or on the sales pipeline with reference to price elasticity per product. In one embodiment, the simulation may be stored as experimental scenarios and examined by key characteristics (e.g. regions, customers) and analyzed using key figures (e.g. quantity per product, net sales, margins). Further, the enterprise software application may help users to execute price changes and trigger follow-up activities like campaigns with campaign specific prices.

Price calculation requires complex business logic. In some price changes scenarios, price simulation may be required to determine or foresee the impact of price changes. For example, the base price of a product may be changed from 100 EUR/1 Piece to 125 EUR/1 Piece and the discount may be changed from 8% to 6%. Since a discount uses the base price as the calculation basis it is not simple to foresee the calculation result when both the base price and the discount rate are changed at the same time. In another example, one or more customer group specific prices may be created such that future orders from some customers may not use the base price. It is hard to estimate the number of sales orders when different new customer group specific prices may be applied to different group of customers. In yet another example, the sale prices may be changed from 100 EUR/1 Piece to 80 EUR/1 Piece. It is not easy determine the effect on orders having more than 100 Pieces. Further complicating the situation, the same product may be ordered in multiple line items of a single order and the summation of the order quantity may be greater than 100 Pieces.

Embodiments of the present invention may provide a method to perform a price simulation. The method may comprise receiving search criteria for sales orders to perform simulation of price changes, selecting sales orders that satisfy the search criteria, and retrieving pricing relevant attributes from the selected sales orders. The pricing relevant attributes may include any discount(s) applied to a base price. The method may further comprise applying a new pricing to affected sales orders and storing simulation results.

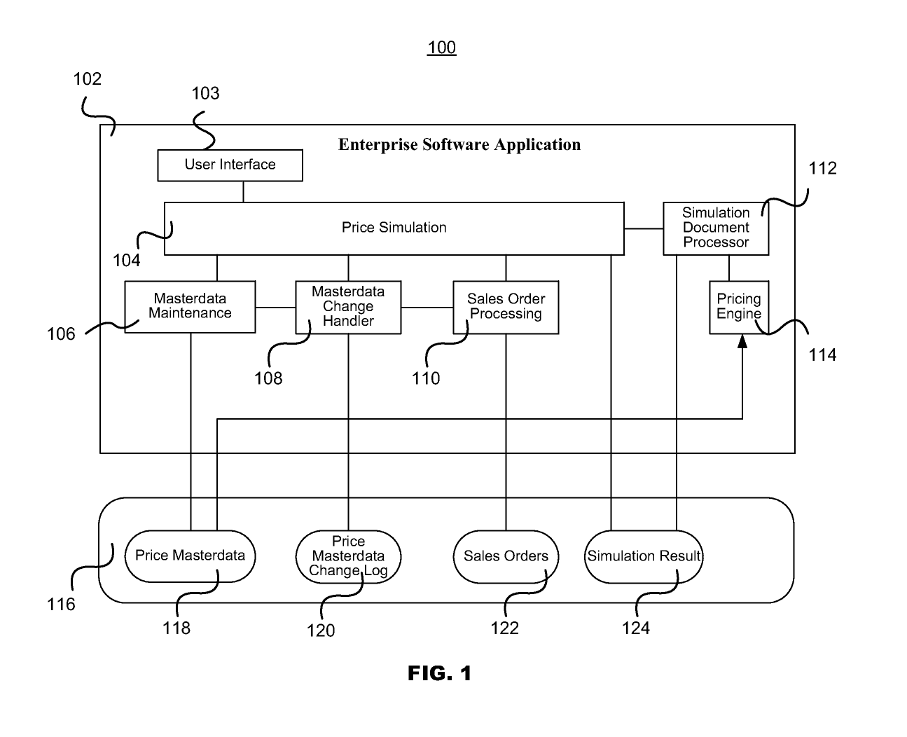

FIG. 1 illustrates a block diagram of an exemplary software system 100 according to the present invention. The software system 100 may comprise an enterprise software application 102 and a data storage 116. The enterprise software application 102 may be a business application that comprises a user interface 103, a price simulation component 104, a masterdata maintenance interface 106, a masterdata change handler 108, a sales order processing component 110, a simulation document processor 112 and a pricing engine 114. The data storage 116 may include price masterdata 118, price masterdata change log 120, sales orders storage 122 and simulation results storage 124. The user interface 103 may interact with users (e.g. display or change price information for a sales order, configure/execute a simulation run) via a web based interface, such as HTML with Adobe® Flash, Microsoft® Silverlight, etc. The UI element may be programmed (e.g., coded) using one of the objected oriented programming languages, such as Java, C#, or scripting languages, such as Java script, PHP, or other suitable programming technologies, such as JSP, ASP.NET, Java Servlet. In one embodiment, the data storage 116 may be part of the enterprise software application 102. In another embodiment, the data storage 116 may be an independent software application. Also, in one embodiment, the various components of the enterprise software application 102 may be distributed among multiple computer servers (including virtual machines), or be hosted on one server machine.

The price simulation component 104 may be a mass data run object (MDRO). That is, the price simulation component 104 may an object that defines and executes price simulations runs (ID, Description etc) and also changes the prices in the price/discount list in simulation run definitions. The masterdata maintenance interface 106 may be an interface between the price simulation component 104 and the price masterdata 118, which stores the price information for sales orders and simulation definitions. The price simulation component 104 may retrieve the price masterdata from the price masterdata storage 118 via the masterdata maintenance interface 106 and also send changes to the price masterdata storage 118 via the masterdata maintenance interface 106. The masterdata maintenance interface 106 may notify the masterdata change handler 108 when a change in the price masterdata is being made. The masterdata change handler 108 may log price changes into the price masterdata change log 120, which may keep tracks of changes being made.

When a user executes a simulation run, the price simulation component 104 may get attributes in the price records from the price masterdata change handler 108. Using the retrieved attributes, the price simulation component 104 may query, via the sales order processing component 110, the existing sales orders stored in the sales orders storage 122 to find relevant sales orders. That is, the sales order processing component 110 may help determine sales orders with attributes of price records in status simulation. With the pricing attributes and sales orders found according to the criteria specified by the user, one or more new simulation documents may be created by the simulation document processor 112. The simulation document processor 112 may ask the pricing engine 114 to determine and calculate prices for a simulation document by fetching the pricing information from the price masterdata 118. The simulation document processor 112 may use the price changes for simulation and the original price of the sales order for determination and calculation. The newly created simulation documents may be stored in the simulation results storage 124. Analytical capabilities may be provided on the documents and stored as well as the pricing information. A sales manager may access these simulation documents using the user interface 103 and price simulation component 104. With these simulation documents, the sales manager may estimate the effect of the simulation with reference to the historical sales records.

In an embodiment, the price masterdata maintenance 106 may do price changes relevant for simulation. Also, in one embodiment, the price masterdata in the price masterdata storage 118 may be set to status “in simulation’ and the pricing engine 114 may determine prices with status “in simulation.” Further, in one embodiment, the prices needs to be released before a price simulation execution based on the prices will be run.

In one embodiment, the price simulation component 104 may contain the details of the simulation parameters. The user (e.g., a sales manager) may create a price simulation run object (e.g., an instantiation of the price simulation component 104) from the UI 103. The user may select a price list (price masterdata) and change it. All the changes may be stored via the price masterdata change handler 108. The user may then run the simulation. In one embodiment, the simulation may be executed in the background task (e.g., by the simulation document processor 112) and the results may be saved and retrieved later. But in another embodiment, the simulation may be executed and the UI may immediately show the result after it is generated.

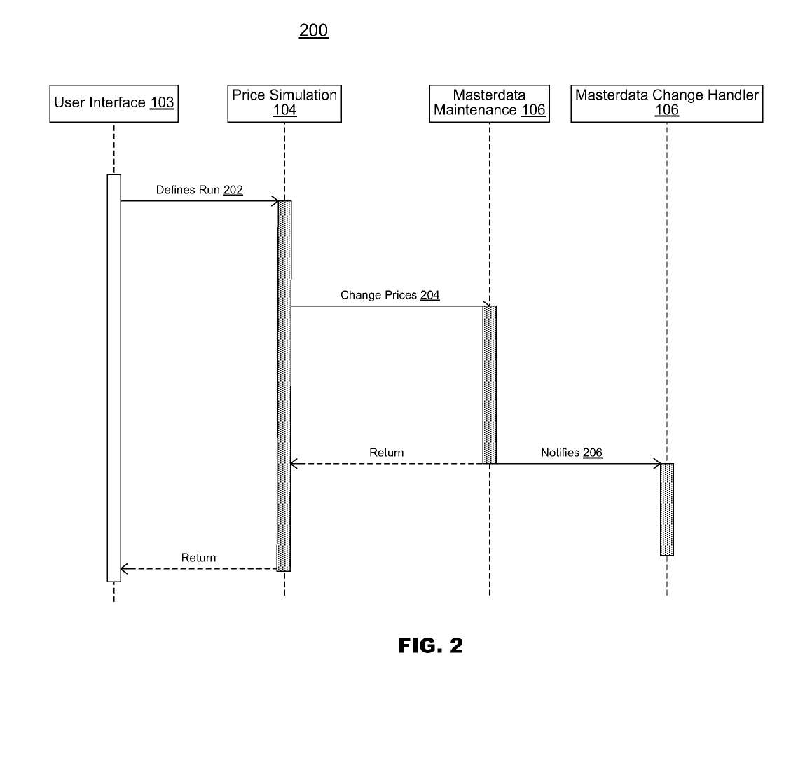

FIG. 2 is a sequence diagram 200 for defining a price simulation run according to an exemplary embodiment of the present invention. The sequence diagram 200 may depict a business flow showing interactions of a user (e.g., a sales manager) and an embodiment of the enterprise software application 102. At step 202, a run may be defined. Via the user interface 103, the user may define a simulation run using the price simulation component 104. The price simulation component 104 may invoke the masterdata maintenance interface 106 to change prices at step 204. When the masterdata maintenance interface 106 finishes performing changes, it may notify the masterdata change handler 106 of any price changes by invoking a method implemented by the masterdata change handler 106 at step 206 and return the control to the price simulation component 104. When the price simulation component 104 finishes the definition run, it may return the control to the user interface 103. In one embodiment, the sequence diagram 200 may represent a process for a sales manager to create a simulation run definition, select the prices to be changed, change the prices and save the simulation run definition with the changed prices.

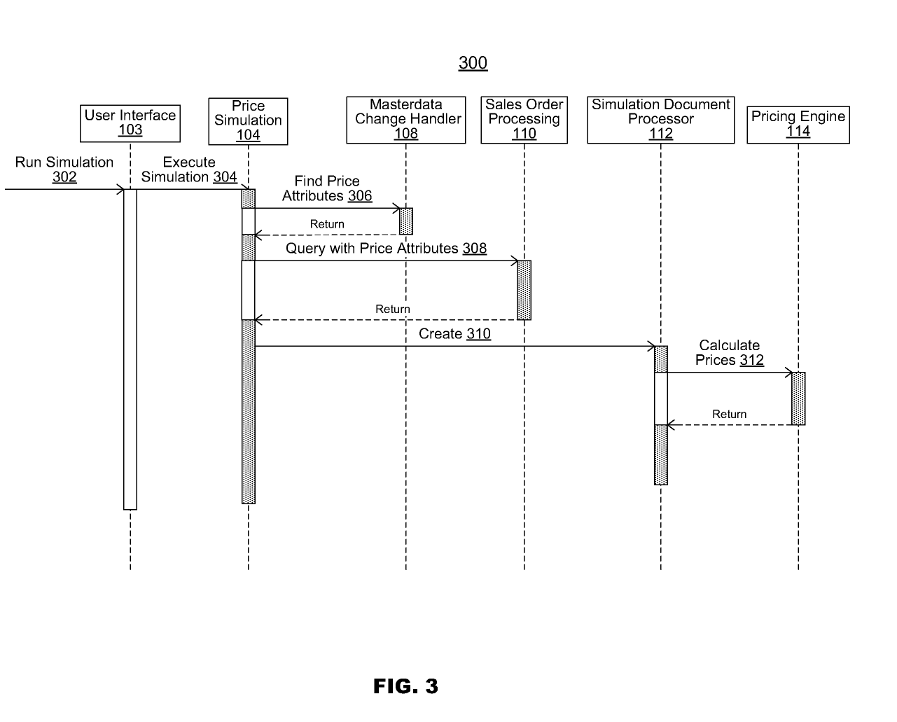

FIG. 3 illustrates a sequence diagram 300 for executing a price simulation run according to an exemplary embodiment of the present invention. At step 302, a user (e.g., a sales manager) may send a command to run a simulation. The simulation run command may be a click on a button or a HTML hyperlink of the user interface 103. The user interface 103 may then, at step 304, invoke an execute simulation method implemented by the price simulation component 104. At step 306, the price simulation component 104 may find price attributes from the masterdata change handler 108. Prices are maintained with certain attributes. For example, price of product ABC for one customer A may be 10 EUR per piece. If a sales manager wants to change the price to 12 EUR per piece, all sales orders for customer A with product ABC may be searched. Thus, a search for sales orders may specify the relevant finding attributes for the sales order (with account and product) selection. In another example, price may depend only on product ID. In yet another example, price may depend upon customer group and product ID.

After obtaining price attributes that match the user's search criteria, the price simulation component 104 may query the sales order processing component 110 with the found price attributes at step 308. When the query step 308 returns, the price simulation component 104 may ask the simulation document processor 112 to create a simulation document at step 310. In creating the simulation document, the simulation document processor 112 may calculate prices using the pricing engine 114 at step 312. In one embodiment, a sales manager may execute a simulation run as illustrated in the sequence diagram 300. Changed price records may be determined using the price masterdata change handler 108 and the attributes of the price records may be returned. With the attribute values, relevant sales orders may be fetched. In an embodiment, for each sales order, a new simulation document may be created by integrating the call to the pricing engine 114.

In one embodiment, the creation of the simulation documents may be done in parallel processing sessions. That is, the user may execute multiple simulation runs concurrently (e.g., in parallel) and do not need to wait for a preceding session to finish before starting a next session. The price results from the reference order (old values) and the new prices given in the pricing engine 114 may be stored in the simulation documents. Analytical capabilities (e.g., Fast Search Infrastructure (FSI) or other query services based on a service-oriented architecture) may be provided with the simulation documents.

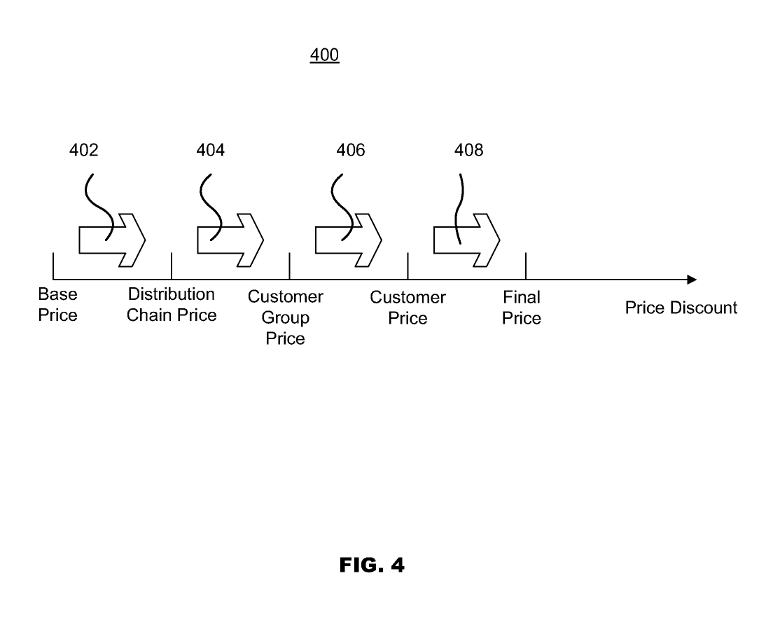

FIG. 4 illustrates a process of applying different price discounts in a sales order simulation according to an exemplary embodiment of the present invention. A sales order may start discounting with a base price. For a distribution chain, the base price may be discounted by a distribution chain dependent discount 402 to arrive at a distribution chain price, which may be different among different distribution chains. Then, for a customer group, the distribution chain dependent price may be further discounted by apply a customer group specific discount 404 to arrive at a customer group price, which may be different among different customer groups. For a particular customer, the customer group price may be further discounted by applying a customer specific discount 406 to arrive at a customer specific price. Further, the customer specific price may be discounted by individual or automatic discount (e.g., a coupon, a sales event) to arrive at the final price. In one embodiment, the discounts may be applied accumulatively. In another embodiment, one or more discounts may be mutually exclusive with other discounts.

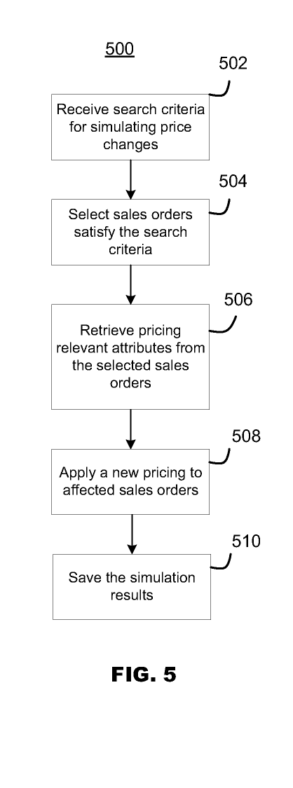

FIG. 5 illustrates a process 500 of executing a price simulation run according to an exemplary embodiment of the present invention. At step 502, criteria for a price change simulation may be retrieved. For example, a user may use the simulation run component 102 to determine criteria of price changes for a simulation. The simulation may be, for example, for sales orders during last three months for a product with a unit price $100. The criteria may include the unit price or product name, and time period. At step 504, affected sales orders may be selected. For example, all sales orders for the product with the unit price $100 may be selected.

At step 506, the pricing attributes may be retrieved from the selected sales order. For example, the unit price may be $100, but for selected sales orders in the last three months, the final sales price may be different for different orders. In an example, three orders may match the search criteria. One order may include 3 units and have a 10% customer specific discount. Two other orders may include a total of 7 units and have no discounts (e.g., sold at the $100 unit price). The discount information for the selected sales orders may be retrieved as the pricing relevant attributes.

At step 508, application of a new pricing to one or more selected sales orders according to the pricing attributes may be simulated. For example, the change from $100 to $110 may be applied only to those orders without any discounts. That is, the new pricing may be applied according to the pricing relevant attributes and may affect only a subset of the selected sales orders. Continuing with the above example of one order having a 10% customer specific discount and two order having no discount, the total revenue may be 3×90%×$100+7×$100=$970. In the simulation, the price change may have no effect on the order having a 10% customer specific discount but may affect the two orders having no discount and thus, the total simulation revenue may be 3×90%×$100+7×$110=$1040. If none of the three orders has any specific discount, all three orders may be affected and the total simulation revenue may be $1100.

At step 510, the simulation results may be saved. For example, the simulation results may be saved in the simulation results storage 124 for future analysis and reporting. In one embodiment, the simulation results may also be replicated to analytical tools for reporting.

In performing simulations, the complexity may increase when multiple prices are changed (prices and discounts) or scale prices are involved, as shown in the above examples. However, in a real business cases, the complexity may be very high and the sales revenue may not be predicted easily. In one embodiment, the selected sales orders used as reference documents for simulation may be any business object that embeds pricing information. For example, in a customer-relationship management (CRM) software application, possible business objects that have pricing information may include sales orders, sales quotes, opportunity, customer invoices, service orders, customer contracts. In a supplier relationship management (SRM) software application, possible business objects that have pricing information may include purchase orders, purchase requests, supplier contracts. Although the above examples use sales orders, other reference objects may also be used. Further, more granular selection criteria for simulation may be implemented. In one or more embodiments, more complex cases with best discounts etc (when multiple discounts are found) may add complexity but may be handled using the process 500 according to the present invention. For example, by repeating the steps 502, 504 and 508, different pricing may be tried to find the relevant historical sales orders where these price changes could have an effect.

In one embodiment, a user may need to log in on the system through the UI 103 to access the simulation functionality. In another embodiment, the effect of price elasticity may also be included in the simulation that may take into account the responsiveness, or elasticity, of the quantity demanded of a good or service to a change in its price. In particular, price elasticity may be used to evaluate the percentage change in demanded quantity in response to a change in price. During the price elasticity simulation, one or more other determinants of demand may be held as a constant (such as income).

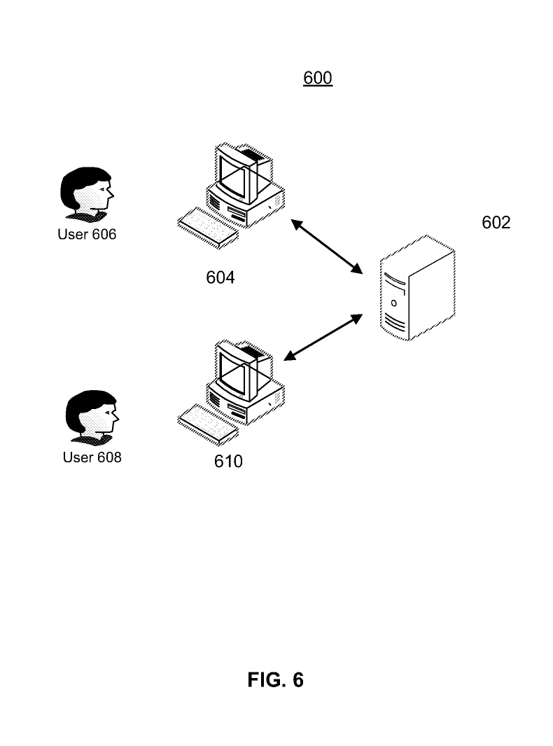

FIG. 6 is another exemplary system 600 implementation according to an exemplary embodiment of the present invention. In the exemplary system 600, a business application for performing the price simulation according to the present invention may be deployed to a business environment and installed on a server 602. Users 606 and 608 may access the business application through their workstations 604 and 610 respectively. Each user 606 or 608 may be a sales manager that can perform price simulations.

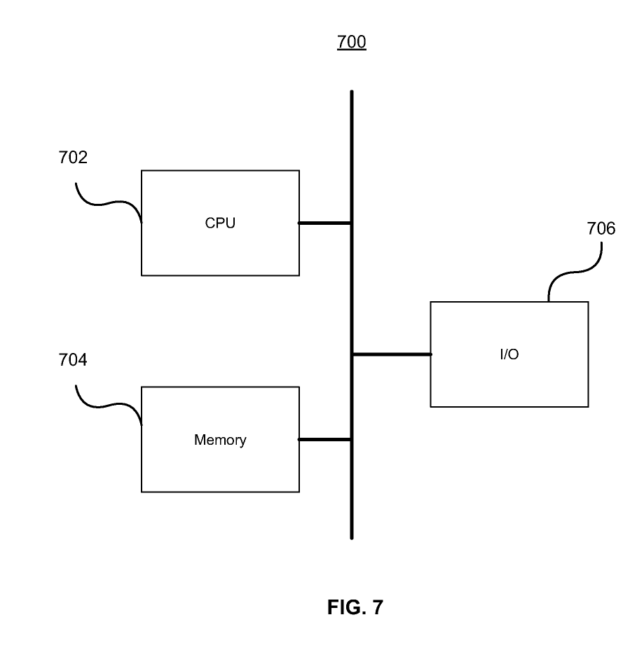

FIG. 7 depicts a structure of a computer server 700 according to one embodiment of the invention. The computer server 700 includes a processor 702, memory 704, and an I/O device(s) 706. The processor 702 is connected to the memory 704 and I/O device(s) 706. These connections are direct or via other internal electronic circuitry or components.

The processor 702 is a programmable processor that executes instructions residing in the memory 704 to receive and send data via the I/O device(s) 706. The instructions may perform the operations of the price simulations described herein. The term programmable processor as used herein is any programmable microprocessor or processor or combination of microprocessors or processors that can operate on digital data, which may be special or general purpose processors coupled to receive data and instructions from, and to transmit data and instructions to, a machine-readable medium. According to one embodiment of the present invention processor 702 is an Intel microprocessor.

Memory 704 is a machine-readable medium that stores data that is processed by processor 702. The term machine-readable medium as used herein is any addressable storage device that stores digital data including any computer program product, apparatus and/or device (e.g., a random access memory (RAM), read only memory (ROM), magnetic disc, optical disc, programmable logic device (PLD), tape, hard drives, RAID storage device, flash memory or any combination of these devices). This may include external machine-readable mediums that are connected to processor 702 via one or more I/O device(s) 706.

The I/O device(s) 706 may be one or more input/output interfaces that receive and/or send digital data to and from an external device. Interfaces as used herein are any point of access to an external device where digital data is received or sent, including ports, buffers, queues, subsets thereof, or any other interface to an external device.

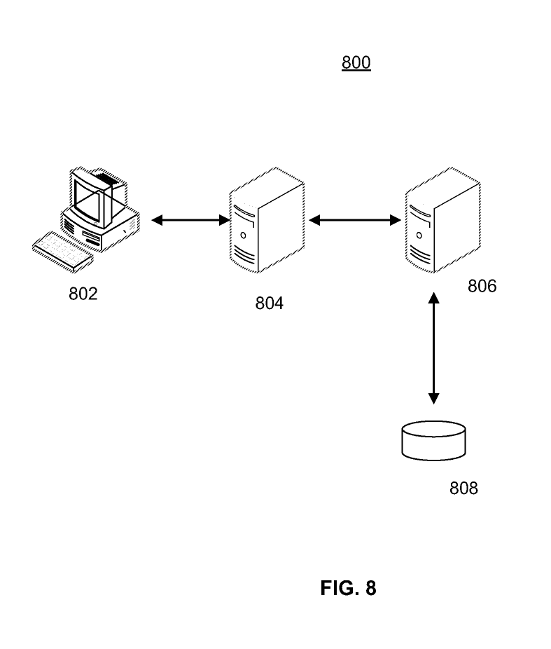

FIG. 8 shows a multi-tier computer system 800 for an enterprise software application that implements a price simulation according to an exemplary embodiment of the present invention. As described above, in one embodiment, the user interface 103, the price simulation component 104 and the data storage 116 may be implemented as a three-tier application. The multi-tier computer system 800 may comprise a user terminal 802, a web server 804, an application server 806 and a database server 808. A portal application may deployed on the web server 804 to be the user interface 103 according to the present invention. The price simulation component 104, masterdata maintenance interface 106, masterdata change handler 108, sales order processing component 110, simulation document processor 112 and pricing engine 114 according to the present invention may be deployed on the application server 806 to be the middle tier performing business processes and the data storage 116 may be deployed on the database server 808 to be the back end tier for data storage.

It should be understood that there exist implementations of other variations and modifications of the invention and its various aspects, as may be readily apparent to those of ordinary skill in the art, and that the invention is not limited by specific embodiments described herein. Features and embodiments described above may be combined with and without each other. It is therefore contemplated to cover any and all modifications, variations, combinations or equivalents that fall within the scope of the basic underlying principals disclosed and claimed herein.

What is claimed is:

1. A method for providing a price simulation, comprising:
receiving search criteria for sales orders to perform simulation of price changes;
selecting sales orders that satisfy the search criteria;
retrieving pricing attributes from the selected sales orders, the pricing attributes including any discount(s) applied to a base price;
simulate application of a new pricing to one or more selected sales orders according to the pricing attributes; and
storing simulation results.

2. The method of claim 1, wherein multiple sessions of price simulation are executed in parallel.

3. The method of claim 1, wherein the simulation results are replicated to a analytical tool for reporting.

4. The method of claim 1, wherein the pricing attributes determine what sales orders are affected for price simulation.

5. The method of claim 1, wherein the pricing attributes includes one or more discounts selected from: distribution chain dependent discount, customer group discount, customer specific discount, individual discount, and automatic discount.

6. The method of claim 1, wherein the price simulation takes price elasticity into consideration by fixing one or more determinants of demand other than price as constant(s).

7. The method of claim 1, further comprising executing price changes to trigger a campaign with a campaign specific price.

8. A machine-readable medium storing instructions adapted to be executed by a computer to perform a method comprising:
receiving search criteria for sales orders to perform simulation of price changes;
selecting sales orders that satisfy the search criteria;
retrieving pricing attributes from the selected sales orders, the pricing attributes including any discount(s) applied to a base price;
simulate application of a new pricing to one or more selected sales orders according to the pricing attributes; and
storing simulation results.

9. The machine-readable medium of claim 8, wherein multiple sessions of price simulation are executed in parallel.

10. The machine-readable medium of claim 8, wherein the simulation results are replicated to a analytical tool for reporting

11. The machine-readable medium of claim 8, wherein the pricing attributes determine what sales orders are affected for price simulation.

12. The machine-readable medium of claim 8, wherein the pricing attributes includes one or more discounts selected from: distribution chain dependent discount, customer group discount, customer specific discount, individual discount, and automatic discount.

13. The machine-readable medium of claim 8, wherein the price simulation takes price elasticity into consideration by fixing one or more determinants of demand other than price as constant(s).

14. The machine-readable medium of claim 8, wherein the method further comprises executing price changes to trigger a campaign with a campaign specific price.

15. A computer system for a price simulation, comprising:
a memory to store computer program instructions; and
a processor configured to execute the computer program instructions to:
receive search criteria for sales orders to perform simulation of price changes;
select sales orders that satisfy the search criteria;
retrieve pricing attributes from the selected sales orders, the pricing attributes including any discount(s) applied to a base price;
simulate application of a new pricing to one or more selected sales orders according to the pricing attributes; and
store simulation results.

16. The computer system of claim 15, wherein multiple sessions of price simulation are executed in parallel.

17. The computer system of claim 15, wherein the simulation results are replicated to a analytical tool for reporting

18. The computer system of claim 15, wherein the pricing attributes determine what sales orders are affected for price simulation.

19. The computer system of claim 15, wherein the pricing attributes includes one or more discounts selected from: distribution chain dependent discount, customer group discount, customer specific discount, individual discount, and automatic discount.

20. The computer system of claim 15, wherein the price simulation takes price elasticity into consideration by fixing one or more determinants of demand other than price as constant(s).

21. The computer system of claim 15, wherein the processor is configured to execute the computer program instructions to further executing price changes to trigger a campaign with a campaign specific price.
